(19) United States
(12) Patent Application Publication
(10) Pub. No.: US 2006/0165962 A1
(43) Pub. Date: Jul. 27, 2006

(54) Coating system for implants for increasing tissue compatibility

(76) Inventors: Alexander J Borck, Aurachtal (DE); Gerd Bayer, Erlangen (DE)

Correspondence Address: HAHN LOESER & PARKS, LLP, One GOJO Plaza, Suite 300, AKRON, OH, 44311-1076, US

(21) Appl. No.: 10/561,774

(22) PCT Filed: Apr. 19, 2004
(86) PCT No.: PCT/EP04/04141

§ 371 Date: Dec. 20, 2005

(30) Foreign Application Priority Data
Jun. 21, 2003 (DE) 103 28 815.5

(51) Int. Cl. B44C 1/17

(52) U.S. Cl. 428/195.1

(57) ABSTRACT

The invention relates to a coating system for implants comprising a metal base body, which is optionally covered with one or several intermediate layers. Said coating system comprises a coating which is disposed thereon in order to increase tissue compatibility. The coating prevents tissue irritations after implantation has an extremely high biocompatibility and has an anti-inflammatory effect. This is achieved by virtue of the fact that the coating comprises a polysaccharide layer made of a) chitosane and b) hyaluronic acid and/or hyaluronic acid derivatives.

### BACKGROUND OF THE INVENTION

The present invention relates to a coating system to increase the tissue compatibility for implants which have a metallic main body.

Implants having a metallic main body for permanent or at least moderate-duration residence in the human or animal body are known to result in rejection reactions in the body, which reduce the functionality of the implant and the success of healing in the treatment. This problem presents itself particularly with stents and electrodes for stimulating body tissue. Therefore, applying coating systems to the implant, which increase the vascular compatibility and therefore reduce the danger of rejection reactions of greatly varying types, is known. The metallic main bodies sometimes have intermediate layers, which are to reduce corrosive processes, as well as improve the tissue compatibility. Intermediate coatings made of amorphous silicon carbide are an example.

Polysaccharides are known as biocompatible. Typical representatives of this substance class are heparin, alginate, chitosan, or hyaluronic acid. The latter two have been shown to be very compatible with the body, and, in addition, coatings made of these components are hydrophilic and therefore the devices provided therewith may be implanted well.

Implants coated with polysaccharides in general and hyaluronic acid specifically and methods for their coating with hyaluronic acid are known in numerous forms from the related art. Thus, U.S. Pat. No. 6,042,876 A discloses a guide wire for implantation purposes which is coated with such a hydrophilic polysaccharide, such as hyaluronic acid or chondroitin sulfate.

U.S. Pat. No. 4,957,744 relates to cross-linked esters of hyaluronic acid which are used for greatly varying medical and cosmetic articles and pharmaceutical compositions. The cross-linked esters result from the esterification of multivalent alcohols with two or more carboxy groups of hyaluronic acid. Such cross-linked esters are particularly usable in the field of bioresorbable plastics for medical and surgical articles.

An implantable stimulation electrode, which displays elevated tissue compatibility, is known from DE 196 30 563. This is achieved in that a thin, specifically functionalized organic coating, which forms essentially the entire external surface of the stimulation electrode, is provided, which adheres permanently to the surface lying underneath it because of irreversible physisorption or covalent bonding. Among other things, silanes and synthetic polymers such as polystyrene sulfonate, polyvinyl sulfonate, or polyallyl amine were suggested as coating materials. The organic coating may also be multilayered, polyethylene oxide or polyethylene glycol being terminated at the external surface in particular. Furthermore, it is claimed that the organic coating contains a medicinal active ingredient, particularly an anti-inflammatory medication, which may be delivered from the organic coating through diffusion or solution.

The described improvements through coating the stimulation electrode do result in a significant reduction of the temporary stimulus threshold increase, but are relatively complex and therefore costly to implement and require extensive tests to evaluate the biocompatibility because of the synthetic nature of the materials used. Furthermore, in the case of the desired addition of anti-inflammatory active ingredients, it is necessary to tailor the material properties of active ingredients and the organic coating in which they are embedded to one another through extensive tests.

Finally, WO 8802623 A1 relates to biomaterials having a biocompatible surface, among other things, the use of hyaluronic acid to manufacture a biocompatible contact lens being disclosed among multiple starting materials and binding mechanisms.

Insofar as the above-mentioned publications relate to coating systems for medical devices and particularly stents and stimulation electrodes, they have the disadvantage that the coatings achieved do not achieve sufficient adhesion strength on the substrate surface, the coatings cover the fine structures of the implants unevenly, and their application is very technically complex.

### BRIEF SUMMARY OF THE INVENTION

An aspect of the present invention is to provide a coating system for implants which overcomes the above-mentioned disadvantages of the related art. In particular, the coating system is to have very high biocompatibility and, in addition, is to have an anti-inflammatory effect per se. Furthermore, the coating system is to comprise as few as possible components, which are easy to process, so that the manufacturing is simplified.

This aspect is achieved by the coating system according to the present invention which have a coating bound through physisorption and/or covalent bonds. The coating covers the metallic main body and possibly one or more intermediate layers applied to the main body. The coating comprises a polysaccharide layer made of

(a) chitosan and

(b) hyaluronic acid and/or hyaluronic acid derivatives.

Surprisingly, it has been shown that the application of such a polysaccharide layer contributes to a significant improvement of the tissue compatibility. Furthermore, hyaluronic acid, its derivatives, and chitosan are distinguished by their very good biocompatibility, since the materials are of natural origin. In addition, it has been shown that at least hyaluronic acid and also its derivatives have an intrinsic anti-inflammatory effect and therefore may effectively prevent or at least strongly reduce tissue irritations.

### DETAILED DESCRIPTION OF THE INVENTION

Hyaluronic acid (hyaluronan) is a simple glycosaminoglycan of the extracellular matrix. It is synthesized on the surface of fibroblasts and occurs as a single glycosaminoglycan, not as a proteoglycan. Hyaluronic acid is a high-molecular-weight compound having M_{R} between 50,000 and several million. The basic component of hyaluronic acid is an aminodisaccharide, synthesized from D-glucuronic acid and N-acetyl-d-glucosamine in β1-3-glycosidic bonding, which has a β1-4-glycosidic bond to the next unit:

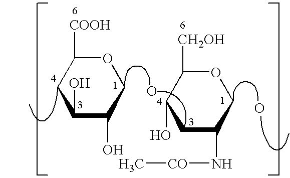

The unbranched chain of hyaluronic acid comprises 2,000-10,000 such units. β-glycosidic bonds are hydrolyzed through hyaluronidase and the hyaluronic acid is thus decomposed into smaller fragments. Commercially available hyaluronic acid—usually as a potassium salt—is isolated from human umbilical cords or cockscombs, but is increasingly manufactured in biotechnology through bacterial fermentation.

Methods known from the literature are used for modifying hyaluronic acid, i.e., preparing hyaluronic acid derivatives (e.g., Danishefsky, Arch. Biochem. Biophys., 90, 1960, p. 114 et seq.; Nagasawa, Carbohydr. Res., 58, 1977, p. 47 et seq.; Ayotte, Carbohydr. Res. 145, 1986, p. 267 et seq.; Ogamo, Carbohydr. Res. 193, 1989, p. 165 et seq.; Jesaja, Can. J. Chem.; 67, 1989, p. 1449 et seq.; Mulloy, Carbohydr. Res. 255, 1994, p.1 et seq.). These are regioselective and stereoselective and non-regioselective and non-stereoselective (static) reactions. Based on these methods, hyaluronic acid may particularly be altered through N and O desulfation, O desulfation, 6-O desulfation, deacetylation, or acetylation, as well as sulfation and acylation with aliphatic or aromatic residues. In particular, through the known methods, amino groups and sulfate or carboxyl residues may be introduced by using protective group chemistry and known, partially regioselective reactions of organic chemistry.

As defined in the present invention, the term “hyaluronic acid derivatives” is understood to include all reaction products which are structurally changed from the starting product through targeted modifications of natural hyaluronic acid. Furthermore, the term “hyaluronic acid and hyaluronic acid derivatives” is understood to include all polyelectrolytic salts thereof, e.g., sodium, potassium, magnesium, and potassium salts. The listed reactions and further known reactions of organic chemistry for reacting the functional groups of hyaluronic acid are considered “modifications” as defined in the present invention.

Hyaluronic acid, the hyaluronic acid derivatives, and chitosan may be immobilized on the implant covalently and/or through physisorption as individual substances, copolymers or block polymers of hyaluronic acid, hyaluronic acid derivatives, and chitosan, and also in the form of mixtures of the above-mentioned individual substances and polymers.

Covalent bonding of the polysaccharide layer to the surface of the implant is preferably performed through single-point or multipoint suspension on spacers. Furthermore, mechanical and/or chemical stabilization of the coating material against enzymatic and hydrolytic degradation and also against mechanical stress is preferably achieved through cross-linking of a previously applied (primary) polysaccharide layer. The immobilization of the polysaccharide layer on the surface of the implants may be performed according to known methods of immobilization of enzymes, methods of membrane manufacturing, plastic processing, polymer chemistry, peptide, protein, and sugar chemistry via covalent bonds with and without the use of spacers, using single point and multipoint suspension, and point suspension as a monolayer or multilayer or with additional stabilization through cross-linking.

A coating having a layer thickness in the range between 10-400 μm, particularly 50-120 μm, has been shown to be advantageous. At the cited layer thicknesses, no significant effect on the functionality of the implant could be determined.

Furthermore, the hyaluronic acid or the hyaluronic acid derivatives may have an average molecular weight in the range from approximately 300,000-500,000, particularly 380,000-420,000 g/mole after sterilization. The intrinsic therapeutic effect of hyaluronic acid and its derivatives reach a maximum in the claimed molecular weight range (Papkonstantinou, G. Karakulakis, O. Eickelberg, A. P. Perruchoud, L. H. Block, and M. Roth; A 340 kDa hyaluronic acid secreted by human vascular smooth muscle cells regulates their proliferation and migration, Glycobiology 1998, 8, 821-830).

A further advantageous aspect of the teaching according to the present invention is the targeted influencing of the in vivo degradation behavior of the biopolymer. The term “degradation behavior” is understood to include degradation of the polysaccharide layer according to the present invention occurring through chemical, thermal, oxidative, mechanical, or biological processes in the living organism over time. It is to be ensured that at least in the first weeks after the implantation, local occurrences of inflammation of the adjoining tissue are reduced or even avoided. However, the coating is to prevent or at least significantly suppress surface adsorption of high-molecular-weight biomolecules on the implant over a specific period of time.

The polysaccharide layer may have a composition such that the in vivo degradation of the polysaccharide layer is slowed from the outside in the direction of the main body of the implant. The degradation behavior may be altered continuously or suddenly in this case. According to the latter variation, the polysaccharide layer comprises at least two partial layers having different degradation behaviors, the degradation behavior within each partial layer being able to be fixed as continuously changeable or constant over the partial layer. The manufacturing of coatings of this type may be performed with the aid of spray and immersion coating methods known per se.

The polysaccharide layer may have a composition such that an external area of the polysaccharide layer, which faces away from the main body of the implant, is degraded within 100 days in vivo. The external area may be 10 to 250 μm, particularly 50 to 150 μm thick. If the polysaccharide layer comprises at least two partial layers having different degradation behaviors, to achieve this goal, an external partial layer may be modified in such a way that this external partial layer is degraded by more than 50 weight-percent within 100 days in vivo. The external partial layer may be 10 to 250 μm, particularly 50 to 150 μm thick.

Surprisingly, it has also been shown that in the presence of the polysaccharide layer according to the present invention, the surface adsorption of high-molecular-weight biomolecules on the implant is also prevented or at least significantly repressed. Therefore, the polysaccharide layer preferably has a composition such that an internal area of the polysaccharide layer, which faces toward the main body of the implant, is not completely degraded within two years in vivo. The internal area may be 3 to 50 μm, particularly 5 to 20 μm thick. If the polysaccharide layer comprises at least two partial layers having different degradation behaviors, to achieve this goal, an internal partial layer, which directly adjoins the surface of the main body underneath it or possibly an intermediate layer applied thereto, may be particularly modified in such a way that this internal partial layer is not degraded by more than 20 weight-percent within two years. The external partial layer may be 3 to 50 μm, particularly 5 to 20 μm thick.

To influence the degradation behavior, the degradation behavior of hyaluronic acid and its derivatives may be influenced by cross-linking, among other things. For this purpose, reference is made in general to the numerous methods described in the literature for performing the individual cross-linking reactions and expressly to the objects of U.S. Pat. No. 4,582,865, U.S. Pat. No. 5,550,187, U.S. Pat. No. 5,510,121, and WO 00/46252. For example, cross-linking may be performed with the aid of the following reagents:

Formaldehyde, glutaraldehyde, divinyl sulfone, polyanhydrides, polyaldehydes, carbodiimides, epichlorohydrin, ethylene glycol diglycidyl ether, butane diol diglycidyl ether, polyglycerol polyglycidyl ether, polyethylene glycol diglycidyl ether, polypropylene glycol diglycidyl ether, or bis or polyepoxy cross-linking agents, such as 1,2,3,4-diepoxybutane or 1,2,7,8-diepoxyoctane.

The relationship between degree of cross-linking and degradation behavior may be determined via typical testing methods. A differing degree of cross-linking results in a differing swelling behavior of the polysaccharide layer. The swelling behavior may be determined gravimetrically, among other things. Furthermore, the degree of cross-linking may also be determined through infrared spectroscopic analysis of cross-linked hyaluronic acid films. The reference for degradation may be produced through a GPC analysis, i.e., through molar mass determination of degraded hyaluronic acid, on eluents.

The influence of the cited modifications on the in vivo degradation behavior is generally known. However, since the degradation behavior is a function of further geometric and physiological factors, among other things, individual adaptation of the system to the particular requirements is typically necessary.

The coating may typically be applied to all known metallic implants. The thin polysaccharide layer made of hyaluronic acid and/or hyaluronic acid derivatives and chitosan is deposited using typical spraying methods or from solution for this purpose.

The manufacturing in principle of a covalently adhering polysaccharide layer is described in WO 00/56377, whose disclosure is incorporated herein by reference in its entirety. A substrate surface is modified with reactive functionalities for this purpose, activated hyaluronic acid is provided, and this is then bound covalently to the reactive functionalities under suitable conditions. The polysaccharide layer according to the present invention may be bound to the surface of the implant in the same way.

Furthermore, DE 196 30 563 (U.S. Pat. No. 5,964,794) discloses a method for improving the adhesion of a coating as a result of reinforced physisorption and/or covalent binding. In a first step, a reactive functionality is produced on the substrate surface. The reactive functionality particularly comprises amines, aldehydes, sulfides, alcohols, acid halogenides, and isocyanates. The polysaccharide layer according to the present invention may then be bound covalently—using coupling methods known per se—to the cited functionality.

The coating system according to the present invention may be supplemented by embedding therapeutic active ingredients, which are released into the surrounding tissue through the gradual degradation of the coating and/or through diffusion.

Furthermore, the polysaccharide layer may comprise an adhesion-promoting layer made of chitosan. The adhesion-promoting layer directly adjoins the main body and possibly the intermediate layer applied thereto. Surprisingly, it has been shown that very uniform and strongly adhering coatings may be produced in the presence of such an adhesion-promoting layer. In addition, chitosan is a material of natural origin and therefore has good biocompatibility. The adhesion-promoting layer may be 0.1 to 50 μm, particularly 1 to 10 μm thick and may be modified like the hyaluronic acid and its derivatives to influence its degradation behavior. In particular, the adhesion-promoting layer may be implemented in such a way that it may act as the internal partial layer or internal area of the polysaccharide layer in the above-mentioned definition.

According to a further preferred variation of the present invention, the polysaccharide layer contains chitosan in at least partial areas or partial layers. In this way, the adhesive capability of the polysaccharide layer may be improved further and uniform coatings may be produced on the often very complex geometries of the substrates.

The stability of the polysaccharide layer may be increased if polycationic charges are produced through quaternization of the amine functions of the chitosan. If hyaluronic acid and/or its derivatives is added as a polyanionic preparation, Symplex gels form. The ion/ion interaction between the components, which is already very strong, may be increased further through cross-linking. A weight component of the chitosan of the total weight of the polysaccharide layer is not more than 50% in one embodiment.

In the first weeks after the implantation of stimulation electrodes, generally a temporary stimulus threshold increase may be determined, which may be attributed to local occurrences of inflammation of the adjoining tissue. These occurrences of inflammation additionally result in unfavorable ingrowth behavior of the stimulation electrodes, which negatively influences the stimulation properties of the system in the long term. This problem may be corrected through the coating system according to the present invention. Therefore, the use of the coating system in this context is claimed.

Stents are implanted very frequently in the course of acute myocardial treatment. However, renewed closure of the opened vessel (restenosis) often occurs in the course of time due to specific microbiological processes. This can be counteracted effectively using the coating system according to the present invention. Therefore, the use of the coating system in this context is claimed.

In the following, the present invention will be explained in greater detail on the basis of exemplary embodiments

### Exemplary Embodiment 1

### Chitosan as a Partial Layer

The following method descriptions are particularly suitable for manufacturing a coating system according to the present invention on stents or stimulation electrodes.

The implant surface was previously cleaned, degreased, and stirred lightly for 10 minutes at room temperature in a 0.5 to 2% acetic acid solution having a chitosan concentration between 0.1% and 0.5%. The molecular weight of the chitosan was between 100,000 g/mole and 1,000,000 g/mole. The implant was subsequently removed and dried.

Alternatively, a thin layer made of chitosan may be applied to the implant through spraying. For this purpose, a 0.5% chitosan solution in 0.5% acetic acid was used. The previously cleaned implants were sprayed 5 to 20 times at intervals of 15 to 30 seconds for 0.5 to 1.0 seconds with the aid of an airbrush gun, the implants being dried at 40° C. to 70° C. between the spraying steps. The applied layers have a layer thickness of 1 μm to 10 μm.

After drying, the implant was laid in an aqueous solution of hyaluronic acid having a molecular weight of at least 1,000,000 g/mole with light stirring for 10 minutes at room temperature. After removal and drying, the implant was immersed for at least 2 hours at approximately 30° C. to 40° C. in a cross-linking agent solution of 2 to 4 ml glutaraldehyde in a water-acetone mixture. The cross-linking agent solution was then replaced and the cross-linking was continued for 2 hours. The experimental conditions also resulted in cross-linking of chitosan with glutaraldehyde. The acid-catalyzed reaction of aldehyde with the amine of the chitosan occurred with the formation of a Schiff base.

The implant was then washed multiple times with distilled water and reductively fixed using a diluted solution of sodium cyanoborohydride and washed multiple times with deionized water. The posttreatment resulted in reduction of the Schiff base and free aldehyde functions. After removal, the sample was dried for 24 hours at 50° C. in the drying cabinet.

The chitosan functions as an adhesion-promoting agent, since chitosan itself is poorly soluble in the neutral range (blood). In addition, the chitosan is provided in cross-linked form and also forms a covalent bond to the applied hyaluronic acid layer through the cross-linking with the aid of the glutaraldehyde. The thin adhesion-promoting layer made of chitosan of 0.1 μm to 50 μm, preferably 1 μm to 10 μm, does not result in any significant impairment of the electrical transmission properties of the electrodes.

### Exemplary Embodiment 2

### Chitosan as an Additive

In addition to the polyanions hyaluronic acid and/or its hyaluronic acid derivatives, the coating system also contains the polycationic chitosan. A further functional group for the cross-linking agent glutaraldehyde is also provided by the amine of the chitosan. The aldehyde function may react both with the amine function of the chitosan and also with the carbonyl and/or hydroxyl function of the hyaluronic acid. The degree of cross-linking may be increased further and the ionic interaction between the polyanions and polycations may be additionally reinforced through these reactions. The layered system made of polyanions and polycations may be produced through alternating spraying of the implant with solutions of desired concentrations of chitosan, hyaluronic acid, and hyaluronic acid derivatives.

For this purpose, previously cleaned implants are alternately sprayed with an aqueous solution of hyaluronic acid or hyaluronic acid derivatives and chitosan dissolved in acetic acid. In this case, the concentration of the hyaluronic acid or hyaluronic acid derivatives is 0.1% to 1%, or 0.2 to 0.5%. The concentration of the acetic acid is 0.1% to 2%, or 0.5% to 1%. The concentration of the chitosan is 0.1% to 1%, or 0.2% to 0.5%. The molecular weight of the hyaluronic acid or the hyaluronic acid derivatives may be at least 1,000,000 g/mole and the molecular weight of the chitosan may be at least 100,000 g/mole. Both solutions are applied alternately to the implant with the aid of a spray method at intervals of 2 seconds to 60 seconds, preferably 15 seconds to 30 seconds. The particular proportion of polyanions and polycations may be set through the selection of the concentration of hyaluronic acid and/or chitosan and the particular spray duration. The weight component of chitosan in the overall layer system is not more than 50%. The number of spraying steps determines the layer thickness of the overall layer system. Thus, with 60 spray steps having a spray duration of 0.5 seconds, layer thicknesses between 5 μm and 10 μm, measured in the dry state, are achieved using typical airbrush guns. After the coating, the and subsequently immersed for at least 2 hours at approximately 30° C. to 40° C. in a cross-linking agent solution of 2 to 4 ml glutaraldehyde in a water-acetone mixture. The cross-linking agent solution is then replaced for at least a further 2 hours. Subsequently, the implant is washed multiple times using distilled water and reductively fixed using a diluted solution of sodium cyanoborohydride, and washed multiple times using deionized water. After removal, the sample is dried for 24 hours at 50° C. in the drying cabinet.

Investigations of the Swelling Behavior

Differing degrees of cross-linking result in differing swelling behavior of the polysaccharide layer. The swelling behavior may be determined gravimetrically, among other ways. Furthermore, the degree of cross-linking may also be determined through infrared spectroscopic analysis on cross-linked hyaluronic acid films. The reference for degradation may be produced through a GPC analysis, i.e., through molar mass determination of degraded hyaluronic acid, on eluents.

In order to determine the influence of cross-linking parameters on the cross-linking and therefore also on the swelling behavior, the parameters of temperature, water content, type of cross-linking agent, and cross-linking duration were varied. Hyaluronic acid films were cast and cross-linked to determine the correlation between swelling behavior and the cross-linking parameters.

### EXAMPLES 1 THROUGH 8

### Experiments on the Swelling Behavior

The method according to Example 1 was divided into the following steps:

(a) preparing a 1% hyaluronic acid solution;

(b) pouring 3 ml 1% hyaluronic acid solution into Petri dishes having 4 cm diameter and subsequent drying;

(c) adding 4 ml cross-linking agent solution to the films at room temperature (20° C.), the cross-linking agent solution comprising 240 ml acetone, 80 ml 25% glutaraldehyde solution, and 1.6 ml 3 molar hydrochloric acid;

(d) cross-linking duration 20 hours, the cross-linking agent solution having been replaced after 4 hours;

(e) removal and washing with deionized water;

(f) adding 4 ml 2.2% NaBH₃CN solution;

(g) washing with deionized water;

(h) drying.

The further Examples 2 through 8 deviated as follows, with otherwise identical method control:

In Example 2, the cross-linking duration in step (d) was 4 hours without replacement of the cross-linking agent solution.

In Example 3, the cross-linking duration in step (d) was 2 hours without replacement of the cross-linking agent solution.

In Example 4, the cross-linking agent solution cited in step (c) additionally contained 20 ml deionized water.

In Example 5, the cross-linking agent solution cited in step (c) additionally contained 100 ml deionized water.

In Example 6, the cross-linking agent solution cited in step (c) contained 80 ml 25% formaldehyde solution instead of the glutaraldehyde solution.

In Example 7, the cross-linking in step (d) was performed at 30° C. and the cross-linking duration in step (d) was 6.5 hours, the cross-linking solution having been replaced after 1.5 hours.

In Example 8, the cross-linking in step (d) was performed at 30° C. and the cross-linking duration in step (d) was 7 hours, the cross-linking solution having been replaced after 2 hours.

After drying the cross-linked films, these were weighed and subsequently washed in deionized water for 30 minutes, blotted briefly and weighed again in order to determine the swelling behavior, which correlates with the degree of cross-linking.

The swelling factors determined may be inferred from the following table:

TABLE 1
swelling factors

| Example | 1 | 2 | 3 | 4 | 5 | 6 | 7 | 8 |
|---|---|---|---|---|---|---|---|---|
| Swelling | 6 | 14 | 75 | 7 | 7 | 34 | 10 | 13 |
| factor | | | | | | | | |

The exemplary experiments on cross-linking led to the following conclusions:

The cross-linking duration has a significant influence on the degree of cross-linking, which is reflected in the swelling behavior. At a cross-linking duration of only 2 hours, hyaluronic acid films were obtained which were unstable and dissolved within a few hours in water. In contrast, at a cross-linking duration of 4 hours, stable hyaluronic acid films were obtained, which displayed a higher swelling factor than the films of the standard method, however. The water content of the cross-linking agent solution did not have a strong influence on the swelling factor, and therefore the degree of cross-linking, in the range examined. The use of formaldehyde instead of glutaraldehyde resulted in cross-linked hyaluronic acid films having a significantly higher swelling factor. This may possibly be attributed to the shorter chain length of the formaldehyde. The shorter cross-linking agent formaldehyde thus results in lightly cross-linked hyaluronic acid films. Cross-linking at a temperature of 30° C. and a cross-linking duration of 7 hours results in hyaluronic acid films having a somewhat higher swelling factor and therefore a lower degree of cross-linking.

We claim:

1. A coating system for implants having a metallic main body, which is optionally covered with one or more intermediate layers, and in which the coating system comprises a coating applied thereto to increase the tissue compatibility,
wherein the coating comprises a polysaccharide layer made of
(a) chitosan and
(b) hyaluronic acid and/or hyaluronic acid derivatives.

2. The coating system according to claim 1, wherein the polysaccharide layer contains chitosan in partial areas or partial layers.

3. The coating system according to claim 2, wherein the polysaccharide layer comprises an adhesion-promoting layer made of chitosan.

4. The coating system according to claim 3, wherein the adhesion-promoting layer is 0.1 to 50 μm thick.

5. The coating system according to claim 1, wherein a component of the chitosan in the total weight of the polysaccharide layer is not more than 50 weight-percent.

6. The coating system according to claim 1, wherein the hyaluronic acid and hyaluronic acid derivatives have an average molecular weight between 300,000 and 500,000 Dalton after sterilization of the implant.

7. The coating system according to claim 6, wherein the average molecular weight is between 380,000 and 420,000 Dalton.

8. The coating system according to claim 1, wherein the polysaccharide layer has a composition such that the in vivo degradation of the polysaccharide layer is slowed from the outside in the direction of the main body of the implant.

9. The coating system according to claim 8, wherein an internal area of the polysaccharide layer is not degradable, at least completely, within two years.

10. The coating system according to claim 9, wherein the internal area is 3 to 50 μm thick.

11. The coating system according to claim 8, wherein an external area of the polysaccharide layer is degradable in vivo within 100 days.

12. The coating system according to claim 11, wherein the external area is 10 to 250 μm thick.

13. The coating system according to claim 8, wherein the polysaccharide layer comprises at least two partial layers having different degradation behaviors, the degradation behavior within each partial layer being able to be fixed continuously changeably or constant over the partial layer.

14. The coating system according to claim 13, wherein the polysaccharide layer comprises an internal partial layer which is degradable by not more than 20 weight-percent in vivo within 2 years.

15. The coating system according to claim 14, wherein the internal partial layer is 3 to 50 μm thick.

16. The coating system according to claim 13, wherein the polysaccharide layer comprises an external partial layer which is degradable by at least more than 50 weight-percent within 100 days in vivo.

17. The coating system according to claim 16, wherein the external partial layer is 10 to 250 μm thick.

18. The coating system according to claim 8, wherein a layer thickness of the polysaccharide layer is between 10-400 μm.

19. The coating system according to claim 18, wherein the layer thickness is 50-120 μm.

20. The coating system according to claim 8, wherein the hyaluronic acid, the hyaluronic acid derivatives, and the chitosan are components of the polysaccharide layer as individual substances, copolymers, or block polymers made of hyaluronic acid, hyaluronic acid derivatives, and chitosan, or in the form of mixtures of the above-mentioned individual substances.

21. The coating system according to claim 1, wherein the polysaccharide layer is immobilized covalently or through physisorption on the implant.

22. (canceled)

23. (canceled)

24. An endovascular implant comprising the coating system of claim 1.

25. An implantable tissue stimulator comprising the coating system of claim 1.
